(19) United States
(12) Patent Application Publication
(10) Pub. No.: US 2012/0026094 A1
(43) Pub. Date: Feb. 2, 2012

(54) KEYBOARD ASSEMBLY AND PORTABLE ELECTRONIC DEVICE

(76) Inventors: Yuan-Hsiang Chuang, Taipei Hsien (TW); Hsin-Hao Chen, Taipei Hsien (TW)

(21) Appl. No.: 12/942,983

(22) Filed: Nov. 9, 2010

(30) Foreign Application Priority Data
Aug. 2, 2010 (TW) 099214757

(51) Int. Cl. G06F 3/02

(52) U.S. Cl. 345/168

(57) ABSTRACT

A keyboard assembly includes a keyboard disposed inside a sunken part of a housing of a portable computer, a magnetic metal component combined with the housing, and a magnetic component connected to the keyboard for attracting the magnetic metal component so as to fix the keyboard inside the sunken part of the housing.

### BACKGROUND OF THE INVENTION

1. Field of the Invention

The present invention relates to a keyboard assembly and a portable electronic device, and more particularly, to a keyboard assembly and a portable electronic device for fixing a keyboard with magnetic attraction.

2. Description of the Prior Art

In the conventional procedure of assembling the keyboard is to screw the keyboard on a main body of the notebook computer. For example, a bolt on a bottom of the keyboard can be screwed on a motherboard for assembling the keyboard on the main body of the notebook computer. The bolt can support the keyboard on the motherboard stably. However, it has disadvantages as follows. The bolts support the keyboard with multi-point distribution instead of planar distribution, resulting in floating tactile feeling when operating the keyboard. For preventing interference between the blots and other electronic components on the motherboard, the arrangement of the bolts has to correspond with various types of motherboards, resulting in complicate mechanical design. Furthermore, screwing means increases inconvenience in assembly and repair. For solving above-mentioned problems, U.S. patent application Ser. No. 12/652,732 discloses a rotary mechanism for fastening the keyboard without utilizing screws for reducing difficulty and manufacture cost of assembly. However, it needs manufacturing precision to engage hooks on the keyboard inside slots on the housing. In conclusion, there is a need to design a keyboard assembly capable of being installed easily and conveniently.

### SUMMARY OF THE INVENTION

The present invention provides a keyboard assembly and a portable electronic device for fixing a keyboard with magnetic attraction for solving above drawbacks.

According to the claimed invention, a keyboard assembly includes a keyboard disposed inside a sunken part of a housing of a portable electronic device, a magnetic metal component combined with the housing, and a magnetic component connected to the keyboard for attracting the magnetic metal component so as to fix the keyboard inside the sunken part of the housing.

According to the claimed invention, the magnetic component is a rubber magnet.

According to the claimed invention, the keyboard assembly further includes a releasing mechanism for pushing the keyboard so as to separate the keyboard from the sunken part of the housing.

According to the claimed invention, the releasing mechanism includes a pin passing through the sunken part of the housing, and a pressing component for driving the pin to push the keyboard so as to separate the keyboard from the sunken part of the housing when being pressed.

According to the claimed invention, a plurality of hooks is formed on a lateral side of the keyboard for inserting inside a plurality of slots of the housing.

According to the claimed invention, a portable electronic device includes a housing whereon the sunken part is formed, and a keyboard assembly installed on the housing. The keyboard assembly includes a keyboard disposed inside the sunken part of the housing, a magnetic metal component combined with the housing, and a magnetic component connected to the keyboard for attracting the magnetic metal component so as to fix the keyboard inside the sunken part of the housing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a portable electronic device according to a preferred embodiment of the present invention.

FIG. 2 is a diagram showing a keyboard assembly according to the preferred embodiment of the present invention.

FIG. 3 is a diagram of a keyboard combining with a magnetic component according to the preferred embodiment of the present invention.

FIG. 4 is a diagram of a housing according to the preferred embodiment of the present invention.

FIG. 5 is an enlarged diagram of the keyboard assembly according to the preferred embodiment of the present invention.

### DETAILED DESCRIPTION

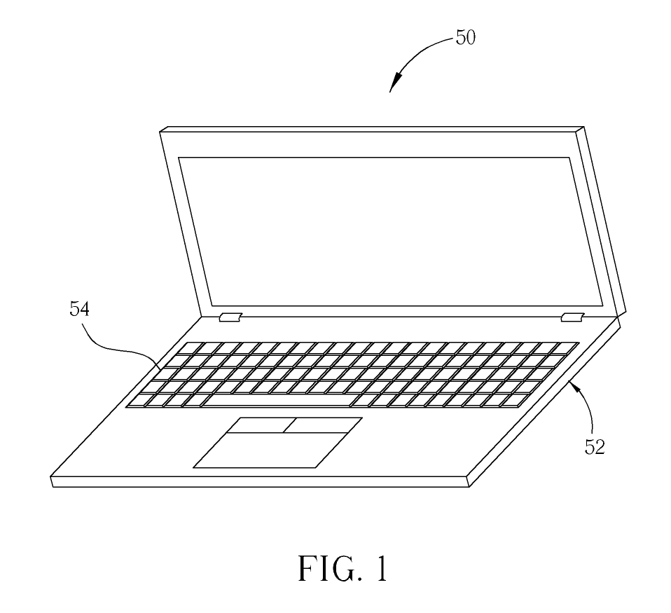

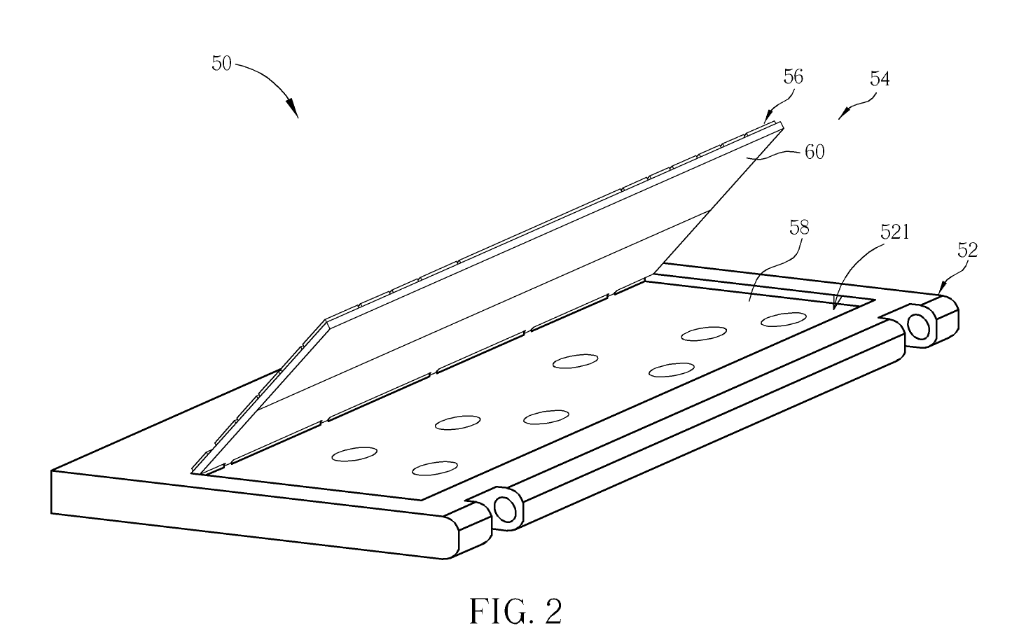

Please refer to FIG. 1. FIG. 1 is a schematic drawing of a portable electronic device 50 according to a preferred embodiment of the present invention. The portable electronic device 50 can be a notebook computer. The portable electronic device 50 includes a housing 52 for covering internal components. The portable electronic device 50 further includes a keyboard assembly 54 installed on the housing 52. Please refer to FIG. 2. FIG. 2 is a diagram showing the keyboard assembly 54 according to the preferred embodiment of the present invention. For clearly illustration, a display of the portable electronic device 50 is omitted herein. The keyboard assembly 54 includes a keyboard 56, a magnetic metal component 58, and a magnetic component 60. A sunken part 521 is formed on a side of the keyboard 52, and the keyboard 56 is disposed inside the sunken part 521 of the housing 52. The magnetic metal component 58 is combined with the housing 52, and the magnetic metal component 58 can be an iron plate. The magnetic component 60 is connected to the keyboard 56 for attracting the magnetic metal component 58 so as to fix the keyboard 56 inside the sunken part 521 of the housing 52. The magnetic component 60 can be a magnet, such as a rubber magnet made by injection molding. The housing 52 can be a magnetic metal housing, for integrating the magnetic metal component 58 and the housing 52 as unity structure for being attracted by the magnetic component 60.

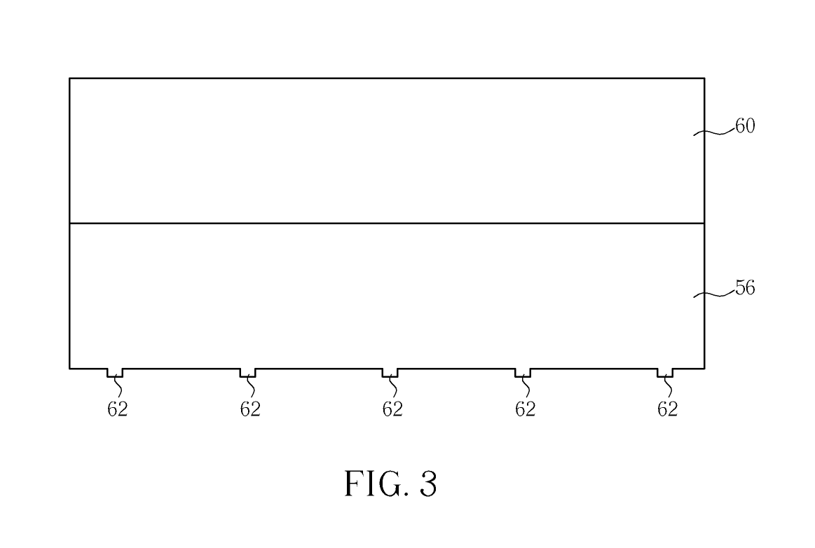

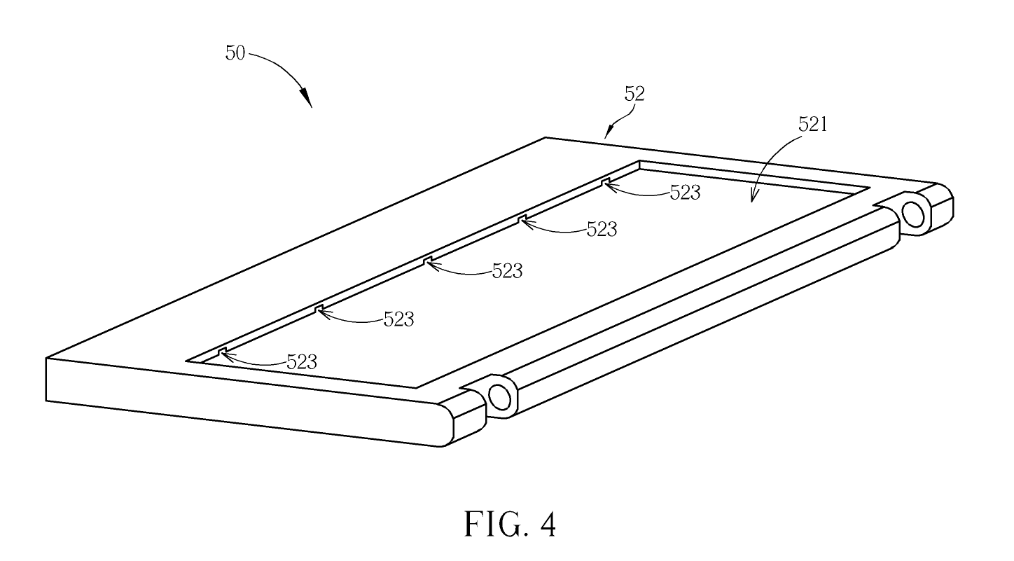

Please refer to FIG. 3. FIG. 3 is a diagram of the keyboard 56 combining with the magnetic component 60 according to the preferred embodiment of the present invention. The magnetic component 60 can be installed on the back of the keyboard 56, that is, disposed on the side of the keyboard 56 facing the sunken part 521 of the hosing 52. For example, the magnetic component 60 can be glued on the back of the keyboard 56 or combined with the keyboard 52 in other manners. Besides, a plurality of hooks 62 is formed on a lateral side of the keyboard 56. Please refer to FIG. 4. FIG. 4 is a diagram of the housing 52 according to the preferred embodiment of the present invention. A plurality of slots 523 is formed on the housing 52 adjacent to the sunken part 521. The plurality of hooks 62 on the keyboard 56 can be respectively inserted inside the plurality of slots 523 on the housing 52 so as to fix the keyboard 56 inside the sunken part 521 of the housing 52. That is, the keyboard 56 of the present invention can be fastened inside the sunken part 521 of the housing 52 stably due to magnetic attraction of the magnetic component 60 on the keyboard 56 and the magnetic metal component 58 on the housing 20 and engagement of the plurality of hooks 62 on the keyboard 56 and the plurality of slots 523 on the housing 52. It provides a keyboard fixing mechanism with easy assembly and without utilizing screws. Furthermore, the engagement of the plurality of hooks 62 on the keyboard 56 and the plurality of slots 523 on the housing 52 can be applied selectively, and the keyboard 56 is fastened inside the sunken part 521 of the housing 52 stably only with magnetic attraction of the magnetic component 60 on the keyboard 56 and the magnetic metal component 58 on the housing 20. It depends on actual design demand.

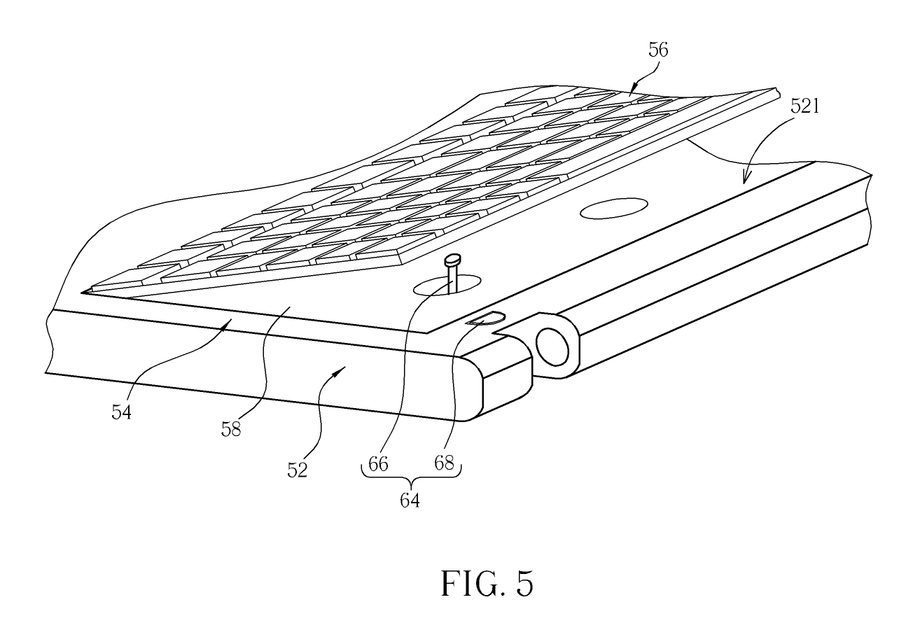

Please refer to FIG. 5. FIG. 5 is an enlarged diagram of the keyboard assembly 54 according to the preferred embodiment of the present invention. The keyboard assembly 54 further includes a releasing mechanism 64 for pushing the keyboard 56 so as to separate the keyboard 56 from the sunken part 521 of the housing 52. The releasing mechanism 64 includes a pin 66 passing through the sunken part 521 of the housing 52 and disposed on the side of the keyboard 56. The releasing mechanism 64 further includes a pressing component 68 for driving the pin 66 to push the keyboard 56 so as to separate the keyboard 56 from the sunken part 521 of the housing 52 when being pressed. For example, the pin 66 and the pressing component 68 can be formed as a seesaw structure. When the user presses the pressing component 68 downward, the pin 66 can be moved up to lift the housing 52 upward so as to separate the keyboard 56 from the sunken part 521 of the housing 52. The mechanical design of the releasing mechanism 64 is not limited to the above-mentioned embodiment. For example, the releasing mechanism 64 can be a stick passing through a bottom of the housing 52 and the sunken part 521 of the housing 52 for lifting up the keyboard 52. The releasing mechanism 64 also can be applied selectively, and the user can pry the keyboard 56 directly to overcome the attraction force between the magnetic component 60 and the magnetic metal component 58.

In contrast to the prior art, the keyboard assembly and the portable electronic device of the present invention utilizes the magnetic attraction force to fasten the keyboard instead of screws. It can reduce difficulty and manufacture cost of assembly and can improve the floating tactile feeling of the conventional keyboard assembly due to the magnetic attraction with planar distribution of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyboard assembly comprising:
a keyboard disposed inside a sunken part of a housing of a portable electronic device;
a magnetic metal component combined with the housing; and
a magnetic component connected to the keyboard for attracting the magnetic metal component so as to fix the keyboard inside the sunken part of the housing.

2. The keyboard assembly of claim 1, wherein the magnetic component is a rubber magnet.

3. The keyboard assembly of claim 1, further comprising a releasing mechanism for pushing the keyboard so as to separate the keyboard from the sunken part of the housing.

4. The keyboard assembly of claim 3, wherein the releasing mechanism comprises:
a pin passing through the sunken part of the housing; and
a pressing component for driving the pin to push the keyboard so as to separate the keyboard from the sunken part of the housing when being pressed.

5. The keyboard assembly of claim 1, wherein a plurality of hooks is formed on a lateral side of the keyboard for inserting inside a plurality of slots of the housing.

6. A portable electronic device comprising:
a housing whereon the sunken part is formed; and
a keyboard assembly installed on the housing, the keyboard assembly comprising:
a keyboard disposed inside the sunken part of the housing;
a magnetic metal component combined with the housing; and
a magnetic component connected to the keyboard for attracting the magnetic metal component so as to fix the keyboard inside the sunken part of the housing.

7. The portable electronic device of claim 6, wherein the magnetic component is a rubber magnet.

8. The portable electronic device of claim 6, wherein the keyboard assembly further comprises a releasing mechanism for pushing the keyboard so as to separate the keyboard from the sunken part of the housing.

9. The portable electronic device of claim 8, wherein the releasing mechanism comprises:
a pin passing through the sunken part of the housing; and
a pressing component for driving the pin to push the keyboard so as to separate the keyboard from the sunken part of the housing when being pressed.

10. The portable electronic device of claim 6, wherein a plurality of slots is formed on the housing, and a plurality of hooks is formed on a lateral side of the keyboard for inserting inside the plurality of slots of the housing.
